(19) United States
(12) Patent Application Publication
(10) Pub. No.: US 2014/0337144 A1
(43) Pub. Date: Nov. 13, 2014

(54) System And Method For Facilitation Of The Marketing And Sale of High Value Items Over A Network

(71) Applicant: Fraser Seymour, Middletown, MD (US)

(72) Inventor: Fraser Seymour, Middletown, MD (US)

(21) Appl. No.: 14/197,183

(22) Filed: Mar. 4, 2014

Related U.S. Application Data
(60) Provisional application No. 61/773,119, filed on Mar. 5, 2013.

(51) Int. Cl. G06Q 30/06; G06Q 30/02

(52) U.S. Cl. CPC G06Q 30/0635; G06Q 30/0276
USPC 705/14.72

(57) ABSTRACT

The present invention provides a method and system to facilitate the marketing and sales processes of customer's high value items over a network using machine automation and without the need for a human broker.

### CROSS-REFERENCE TO RELATED APPLICATIONS

The present application for patent claims priority to Provisional U.S. Application No. 61/773,119 entitled “System And Method For Facilitation Of The Marketing And Sale of High Value Items Over A Network” filed on Mar. 5, 2013, which expressly incorporated by reference herein.

### FIELD OF THE INVENTION

The present invention relates to a system and method to facilitate the marketing and sales processes of items of high value over a network, and components thereof

### BACKGROUND OF THE INVENTION

The process of marketing and selling high value items (“HVI”) i.e. items with a relatively large monetary value (e.g. real estate, boats, aircraft, certain land vehicles, businesses etc.) is different than the processes associated with marketing and selling low or moderate value items. Due to the large monetary value and in many cases the complexity of HVIs, sales processes should contain mechanisms that protect the seller of the HVI from fraud on the part of the buyer and provide the buyer sufficient opportunity to investigate the quality of title and condition and completeness of the HVI, among other aspects.

Heretofore, the marketing and sale of HVIs has been accomplished through one or more human intermediaries acting in a role as broker or agent between the seller and the buyer. A broker retained by the HVI seller represents the interests their client, said seller. Frequently, the buyer of HVIs also employs a broker intermediary in like fashion.

In theory, these brokers use their market domain and sales process knowledge to advise and provide guidance to their clients. In addition, the brokers may assist in locating 3^{rd} party service providers, and should facilitate communication among the seller, buyer and said 3^{rd} party service providers. Such 3^{rd} party service providers may include, for example, inspectors of said HVI, title investigators, sales transaction closing or settlement administrators, domain-specific finance providers and domain-specific insurance providers, for example.

Other potential benefits of selling a HVI through a broker include i) protection of seller's privacy, ii) availing the seller of market pricing information, iii) advertising the HVI for the seller, iv) monitoring of buyer interest, v) showing said HVI to prospective buyers, vi) advice for negotiation tactics, vii) the form of purchase agreements, viii) access to an escrow account for good faith deposit and ix) providing overall transaction process guidance for seller, buyer or both seller and buyer.

The extent to which a seller or buyer actually receives the aforementioned benefits depend upon the availability, skill, knowledge and integrity of the broker, all of which is very difficult to fully ascertain prior to the engagement of the broker. Any benefits received by the seller are accompanied by large sales commissions, which typically are equal to 6 percent of the contract sales price in the case of real estate transactions, 6-15 percent for aircraft, and 10-15 percent in the case of boat sales, for example. In addition, the presence of the broker as intermediary without transaction automation serves to isolate the seller and buyer from their own transaction, an experience that may not inspire confidence in the desirability of the outcome. In addition, HVI sales efficiency expressed in terms of event response time and overall transaction execution time for human broker intermediated transactions absent the presence of transaction automation is limited by the personal availability of the broker.

The advent of the World Wide Web (“Web”) as an advertising medium has provided sellers with the ability to market their HVI independently. Sellers can now reach their target markets using Web-based auction or classified advertising websites.

In the case of Web-based classified advertising, sellers can advertise their item and buyers can locate the item and contact the seller. Web-based classified advertising websites do not provide any other services to assist sellers with marketing, sales process guidance or transaction facilitation.

In the case of auction websites, sellers can advertise their item, buyers can locate the item and attempt to purchase the item by participating in an online auction, by paying the asking price or by offering another amount for the item, depending upon the method of sale selected by the seller. Payment for the purchased item is typically made by credit card or electronic fund transfer through an intermediary service. Auction websites are adequate for the advertising and sales transaction of items of low or moderate value, but are inadequate for the marketing and sale of HVIs.

There remains a need in the art for automated facilitation of marketing, selling and purchasing high value items delivered by the Web directly to individuals seeking to sell and purchase such HVIs on a person to person basis thereby providing an alternative to human-intermediated brokerage and the like; wherein seller, the buyer or both enjoy an improved experience in terms of one or more of i) the timeliness of access to pertinent information, ii) the transparency and security of the information, iii) the convenience of access to services, and iv) lower transaction costs by obviating the fees levied by human broker or agent intermediaries.

There also remains a need in the art for automated facilitation of marketing, selling and purchasing high value items delivered by the Web for the purpose of increasing the efficiency, productivity and security of transactions by HVI dealership, HVI manufacturers, or intermediated by one or more human brokers, brokerage companies, agents, or agencies, thereby providing the seller, the buyer or both an improved experience in terms of one or more of i) the timeliness of access to pertinent information, ii) the transparency and security of the information, and iii) the convenience of access to services.

### SUMMARY OF THE INVENTION

The present invention overcomes the disadvantages of the background art by providing a method and system to facilitate the marketing and sales processes of customer's high value items (“HVIs”) over a network using machine automation and without the need for a human broker.

To address the shortcomings of the background art, the present invention provides, using client/server computing architecture and a computer network enabling secure communication between and automated HVI marketing and sales facilitation services to be delivered to a plurality of users via user's computing devices.

According to another aspect of the present invention, the marketing, purchase and sale of HVIs is beneficially facilitated for sellers of HVIs and for buyers of HVIs by providing a private virtual environment exclusively for each HVI seller, each HVI buyer and each third-party service provider who is a registered member of the automated HVI marketing and sales facilitation services. The aforementioned private virtual environment is accessible to each member via a dashboard unique to each member's account, and provides interactive services delivered to each seller member and each buyer member over the network using the aforementioned user's computing device.

In general, the seller member dashboard enables said seller to manage the marketing and sale of seller's HVI, the buyer member dashboard enables the buyer to find a candidate HVI to purchase and transact the purchase of said HVI, and third-party service provider member dashboard enables the third-party provider to provide their services to the buyer or seller member that has engaged their services in the purchase transaction. An HVI seller member may be a natural person, an HVI dealership or an HVI manufacturer, for example.

According to another aspect of the present invention, the marketing, purchase and sale of HVIs is beneficially facilitated for sellers of HVIs, for buyers of HVIs and for the human broker or the brokerage company intermediaries representing said buyer, seller or both, by providing a private virtual environment exclusively for each HVI seller, buyer, broker or brokerage company and third-party service provider who is a registered member of the automated HVI marketing and sales facilitation services. The aforementioned private virtual environment is accessible to each member via a dashboard unique to each member's account, and provides interactive services delivered to each member over the network using the aforementioned member's computing device.

It is an advantage of this system that its HVI seller users will be i) well informed of the efficacy of their marketing efforts, ii) well informed of the status of all outstanding purchase offers, iii) well prepared for each phase of the sales transaction, iv) in the case wherein the seller does not use the service of a human broker intermediary, seller users will be enabled to transact the sale of their HVI without the requirement to pay a broker commission fee.

It is another advantage of this system that its HVI buyer users will be i) well served by a more timely response to inquiries and purchase offers, ii) well informed of the status of all outstanding purchase offers, iii) well prepared for each phase of the sales transaction, iv) in the case wherein the seller or buyer do not use the service of a human broker intermediary, buyer users will be enabled to transact the purchase of an HVI without the requirement to pay a higher price to offset seller broker commission costs.

It is another advantage of this system that its third-party service provider users will be i) well served by a more timely response to communications with the seller or buyer members, ii) well informed of the status of the transaction and availability of associated documents, iii) well served by the automatic generation, population and supply of documents necessary to their work efforts (i.e. increase in work processing efficiency), iv) well protected as documents remain within a secure computing environment, and v) able to benefit from direct and timely advertising of their services to prospective clients.

As used herein “substantially”, “generally”, “relatively”, “approximately”, and “about” are relative modifiers intended to indicate permissible variation from the characteristic so modified. It is not intended to be limited to the absolute value or characteristic which it modifies but rather approaching or approximating such a physical or functional characteristic.

References to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

In the following description, reference is made to the accompanying drawings, which are shown by way of illustration to specific embodiments in which the invention may be practiced. The following illustrated embodiments are described in sufficient detail to enable those skilled in the art to practice the invention.

It is to be understood that other embodiments may be utilized and that structural changes based on presently known structural and/or functional equivalents may be made without departing from the scope of the invention.

Hereinafter, various embodiments of the present invention will be explained in more detail with reference to the accompanying figures; however, it is understood that the present invention should not be limited to the following preferred embodiments and such present invention may be practiced in ways other than those specifically described herein.

### BRIEF DESCRIPTION OF THE DRAWINGS

FIG. 1 depicts a constitutional drawing of a network topology reflecting the delivery of services to and among members, as well as allowing non-member visitors limited access to information relating to HVIs made for sale through the services.

FIG. 2 depicts a flow diagram depicting a representative example of services delivered by the system and method described herein, such services delivered to and for the benefit of members; a summary of events, gating logic and operations pertaining to the consummation of a purchase and sale of a HVI between a seller member and a buyer member.

FIG. 3 depicts a flow diagram depicting a representative example of services delivered by the system and method described herein, such services delivered to and for the benefit of members; a greater degree of detail of events, gating logic and operations pertaining to the facilitation of negotiation of a price and terms of purchase and sale of a HVI between a seller member and a buyer member.

FIG. 4 depicts one embodiment representative example of a dashboard used to access the virtual private environment and services provided therewith to each services member. In the present case, the member is a seller member, the services are automated HVI marketing and sales facilitation for HVI seller, the HVI is a boat, and the page shown is the landing page for the seller member's virtual private environment.

FIG. 5 depicts one embodiment representative example of a dashboard used to access the virtual private environment and services provided therewith to each services member. In the present case, the member is a seller member, the services are automated HVI marketing and sales facilitation for HVI seller, the HVI is a boat, and the page shown is the static reference information page which provides guidance, suggestions and opinion for marketing and sale transaction process management.

FIG. 6 depicts one embodiment representative example of an interactive advertisement web page. In the present case, the HVI is a boat, and the displayed content is that which is made available to non-member users (i.e. the general public). This view displays public tier description and textual information, photos etc. and a means to anonymously contact the HVI seller member with inquires.

FIG. 7 depicts one embodiment representative example of a dashboard used to access the virtual private environment and services provided therewith to each services member. In the present case, the member is a seller member, the services are automated HVI marketing and sales facilitation for HVI seller, the HVI is a boat, and the page shown is the HVI information page which guides seller member through the process of constructing a professional-looking advertisement. As part of this guidance, this page also provides a means for the seller member to store and print an information collection guide sheet to facilitate the member's compilation of information necessary for the marketing and sale of the seller member's HVI.

FIG. 8 depicts one embodiment representative example of a dashboard used to access the virtual private environment and services provided therewith to each services member. In the present case, the member is a seller member, the services are automated HVI marketing and sales facilitation for HVI seller, the HVI is a boat, the page shown is the HVI marketing collateral generation page and the action shown is the automatic generation of a professional-looking advertisement brochure in a format suitable for computer storage, sending via email or printing.

FIG. 9 depicts one embodiment representative example of a dashboard used to access the virtual private environment and services provided therewith to each services member. In the present case, the member is a seller member, the services are automated HVI marketing and sales facilitation for HVI seller, the HVI is a boat, the page shown is the HVI marketing collateral generation page and the action shown is the automatic generation of a professional-looking for-sale advertisement sign in a format suitable for computer storage, sending via email or printing. The sign contains a brief custom summary of the particular HVI and contains an automatically-generated code which, when scanned by a mobile device, will cause the advertisement Web page associated with the particular HVI to me displayed upon the mobile device used to perform the scan.

FIG. 10 depicts one embodiment representative example of a dashboard used to access the virtual private environment and services provided therewith to each services member. In the present case, the member is a seller member, the services are automated HVI marketing and sales facilitation for HVI seller, the HVI is a boat, the page shown is the HVI sales transaction process management page which dynamically guides the member though each phase of the sales transaction, displaying the then-current phase, and guidance relevant to the then current phase. This page also provides a repository for automatically generated forms and agreements including purchase offer agreements, acceptance agreements, closing documents and the like. It also provides a means to respond to received purchase offer and acceptance agreements.

FIG. 11 depicts one embodiment representative example of a dashboard used to access the virtual private environment and services provided therewith to each services member. In the present case, the member is a seller member, the services are automated HVI marketing and sales facilitation for HVI seller, the HVI is a boat, the pages shown represent the sequence taken by a buyer member when submitting an offer to purchase an HVI made available for sale through the present invention. Noteworthy is the intuitive offer process: buyer member views the desired HVI and clicks the button to submit an offer. They then complete a simple summary of offer terms, review the long-form purchase agreement which is automatically generated by the present invention and populated with the HVI information and offer terms. The long-form agreement is of a format compatible with computer storage, sending via email or printing. The buyer member reviews the information and submits the offer.

FIG. 12 depicts one embodiment representative example of a dashboard used to access the virtual private environment and services provided therewith to each services member. In the present case, the member is a seller member, the services are automated HVI marketing and sales facilitation for HVI seller, the HVI is a boat, the pages shown represent the sequence taken by a seller member when responding to an purchase offer submitted by a buyer member. Noteworthy is the intuitive process: seller is notified by electronic means (in the present case, email and/or SMS text message) indicating the presence of a purchase offer and a summary of the proposed terms. The seller member then accesses their dashboard where they proceed to the process manager page, select the offer and respond using a simple, intuitive page and process.

FIG. 13 depicts one embodiment representative example of an acceptance agreement generated and populated by the present invention. In the present case, the HVI is a boat. The acceptance agreement sequentially follows the purchase agreement, the performance of any inspections and the satisfaction of any other terms included within the purchase agreement, and is used to provide a means for the buyer to address any outstanding issues with the purchase transaction. Such issues may include defects discovered with the HVI, or the title of the HVI, for example.

FIG. 14 depicts one embodiment representative example of a bill of sale generated and populated by the present invention. In the present case, the HVI is a boat. The bill of sale sequentially follows the acceptance agreement, and provides a means to document the transfer of HVI ownership. Once executed, the bill of sale is one among the documents required to close or settle a purchase transaction.

FIG. 15 depicts one embodiment representative example of a settlement statement generated and populated by the present invention. In the present case, the HVI is a boat. The settlement statement sequentially follows the acceptance agreement, and provides a describes the source and destination of all funds associated with the purchase transaction. Once executed, the settlement statement is one among the documents required to close or settle a purchase transaction.

FIG. 16 depicts one embodiment representative example of a dashboard used to access the virtual private environment and services provided therewith to each services member. In the present case, the member is a seller member, the services are automated HVI marketing and sales facilitation for HVI seller, the HVI is a boat, the page shown facilitates a means to communicate and pass documents between services members without exposing the documents or the information contained therein to the insecure public internet (i.e. email).

FIG. 17 depicts one embodiment representative example of a Web advertisement for an HVI made available for sale though the present invention. In the present case, the HVI is a boat which has been sold, so the advertisement indicates “sold” status. Other status are displayed representing the then-current sales status of the HVI.

### DETAILED DESCRIPTION OF THE INVENTION

The present invention comprises a system and method to facilitate the marketing and sales processes of HVIs over a network using machine automation and without the need for a human broker. In the following description, for purposes of explanation, details are set forth in order to provide a thorough understanding of the present invention. It will be evident, however, to one skilled in the art that the present invention may be practiced without these specific details.

In one embodiment, the network comprises the Internet or another network, the system and method for automated HVI marketing and sales facilitation are implemented using software run on at least one computer, the software provides at least a web server, email servers, electronic commerce gateway (or interface to one or more), SMS telecommunications gateway (or interface to one or more), secure access control, secure access encryption, support for mobile applications, a host web site, a content management system, a database and database management system. Users access the automated HVI marketing and sales facilitation via user's computing device capable of communicating over the network and running browser, mobile “App” or other application software.

The present invention for automated HVI marketing and sales facilitation provides tiered user access comprising i) public, ii) services member and iii) transaction participant contexts; wherein certain information is made available to the public; wherein information and capabilities available only to services members include certain restricted information and the capability to access services provided through the present invention; wherein member services are provided on a subscription basis and controlled via private accounts for each registered member; and wherein information and capabilities available to transaction participants are not available to others.

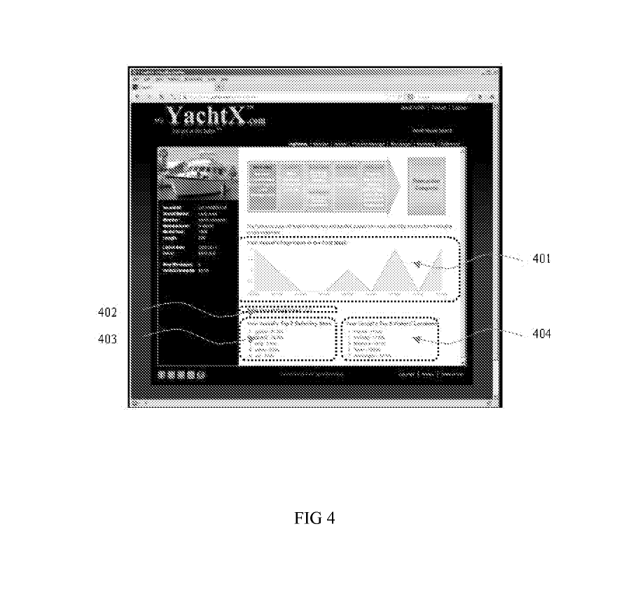

The automated HVI marketing and sales facilitation in the present disclosure provides a private virtual environment exclusively for each HVI seller, each HVI buyer and each third-party service provider who is a registered member of the automated HVI marketing and sales facilitation services. The aforementioned private virtual environment is accessible to each member via a dashboard unique to each member's account (representative example FIG. 4), and provides interactive services delivered to each seller member and each buyer member over the network using the aforementioned user's computing device. Member account security is enforced by password protection access control and secure sockets layer “SSL” or other encryption, the access method to the aforementioned network is not particularly limited.

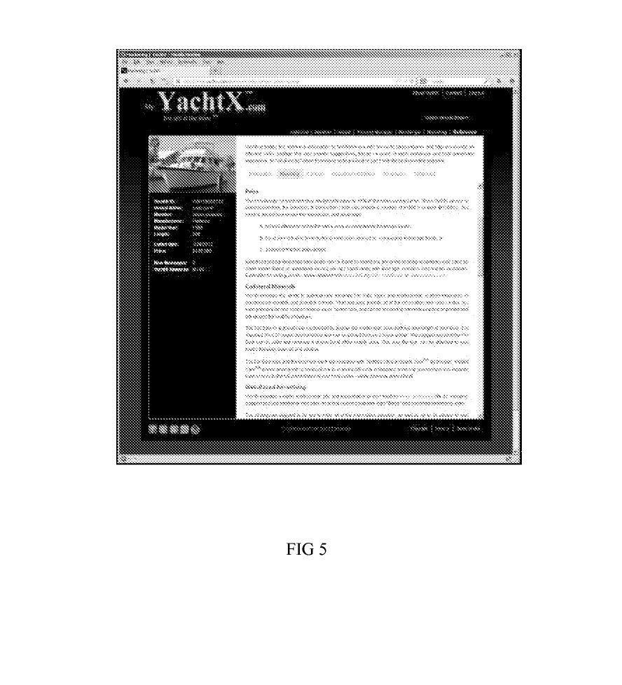

The aforementioned private virtual environment provides seller and buyer members with guidance, suggestions and opinion for marketing and sale transaction process management. These are provided to the seller member and buyer member on the their respective dashboard by one or more techniques selected from a group consisting of i) static information accessible at any time (representative example FIG. 5), ii) as dynamic information pertaining to the then-current stage in the relevant marketing and sales processes (representative example 1001), and iii) in real-time through a dialog box-based online chat facility.

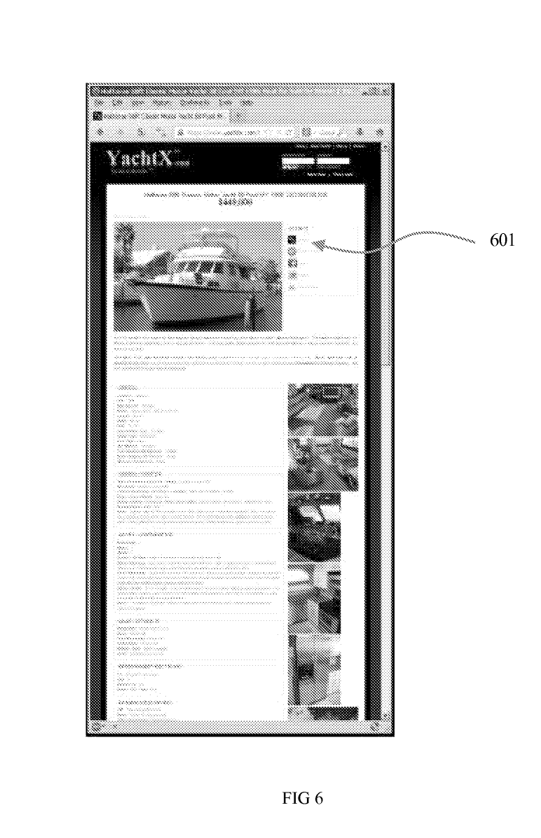

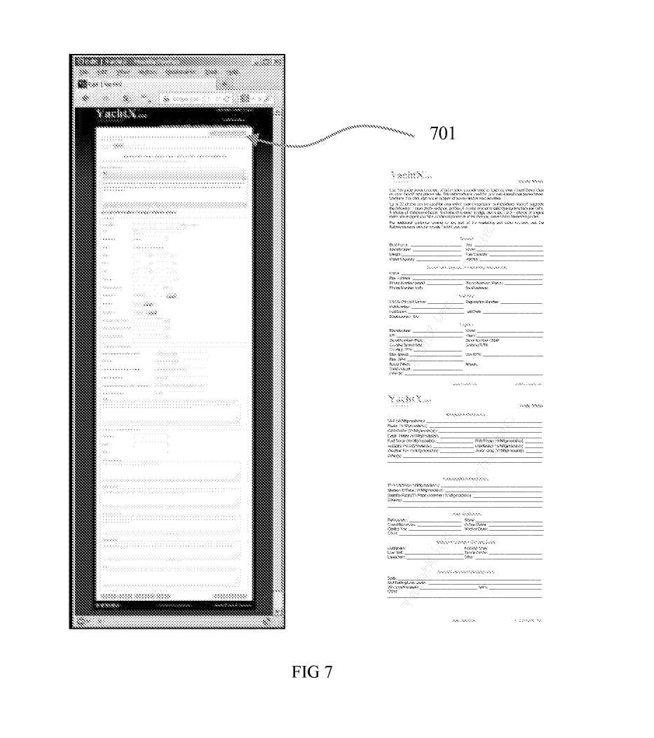

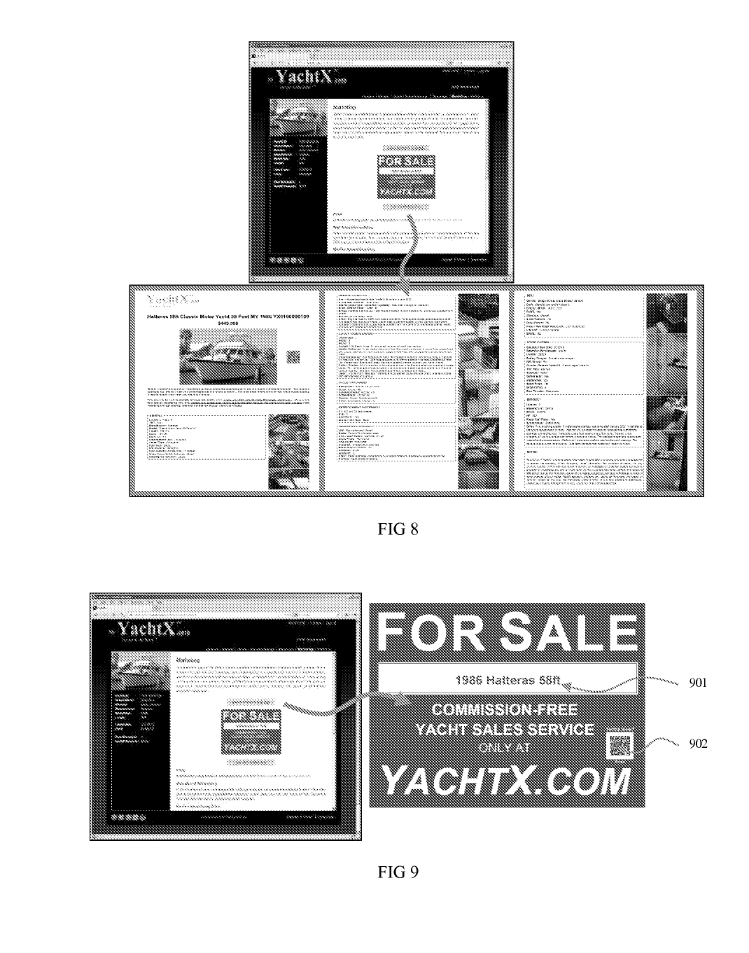

The automated HVI marketing and sales facilitation in the present disclosure provides seller members interactive advertising which is integrated by use of the Internet; wherein the aforementioned advertising includes a Web page (representative example FIG. 6) with a unique uniform resource allocation (“URL”) address using hypertext transfer protocol which may be found via an Internet search engine, via a search conducted at the host web site or via another Internet access application, said Web page displays content describing said HVI as provided and managed by said seller but the seller is guided in the advertisement content (representative example FIG. 7), said content may include photographic images, video images, audio descriptions, written specifications, descriptions and other such information used to describe said HVI, the Web page further provides a capability for submitting inquiries about said HVI without the need for the seller's name or other personal information revealed (representative example 601), the Web traffic for said Web page comprising daily visitors (representative example 401), total visitors (representative example 402), referring URL (representative example 403), geographical location (representative example 404) and other similar information is reported to said seller upon seller's dashboard; wherein said advertising further includes a brochure using a common file format which is capable of being printed or stored electronically or transferred over a network (representative example FIG. 8), said brochure is derived from the information used to populate the aforementioned advertising Web page, said brochure further contains a machine readable embedded link in the form of a code such as a bar-code, QR-code or other such that when read by a machine such as a computer, tablet, smart mobile phone or other device so capable, the aforementioned advertising specification Web page content is automatically displayed upon the screen of said machine; wherein said advertising further includes a for-sale sign (representative example FIG. 9) or an attachment to a for-sale sign, in a common file format which is capable of being printed or stored electronically or transferred over a network, certain information displayed upon said for-sale sign is unique to said HVI (representative example 901) as derived from information used to populate the aforementioned advertising Web page, said for-sale sign further contains a machine readable embedded link in the form of a code such as a bar-code, QR-code (representative example 902) or other such that when read by a machine such as a computer, tablet, smart mobile phone or other device so capable, the aforementioned advertising specification Web page content is automatically displayed upon the screen of said machine in a human viewable and readable format. Seller member dashboard also provides i) an information collection guide sheet on seller's dashboard (representative example 701) which is capable of being printed or stored electronically or transferred over a network, the sheet may be printed and used by the seller to collect relevant information beneficial to creating a thorough presentation of the HVI, ii) information partitioning such that certain information is presented to the public, other information is viewable only to members, and still other information is viewable only by approved parties at appropriate stages of the sales process (representative example 702).

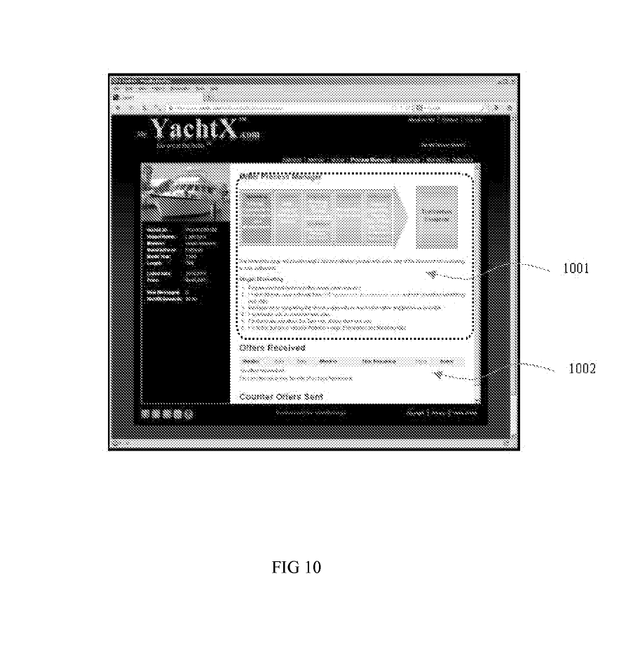

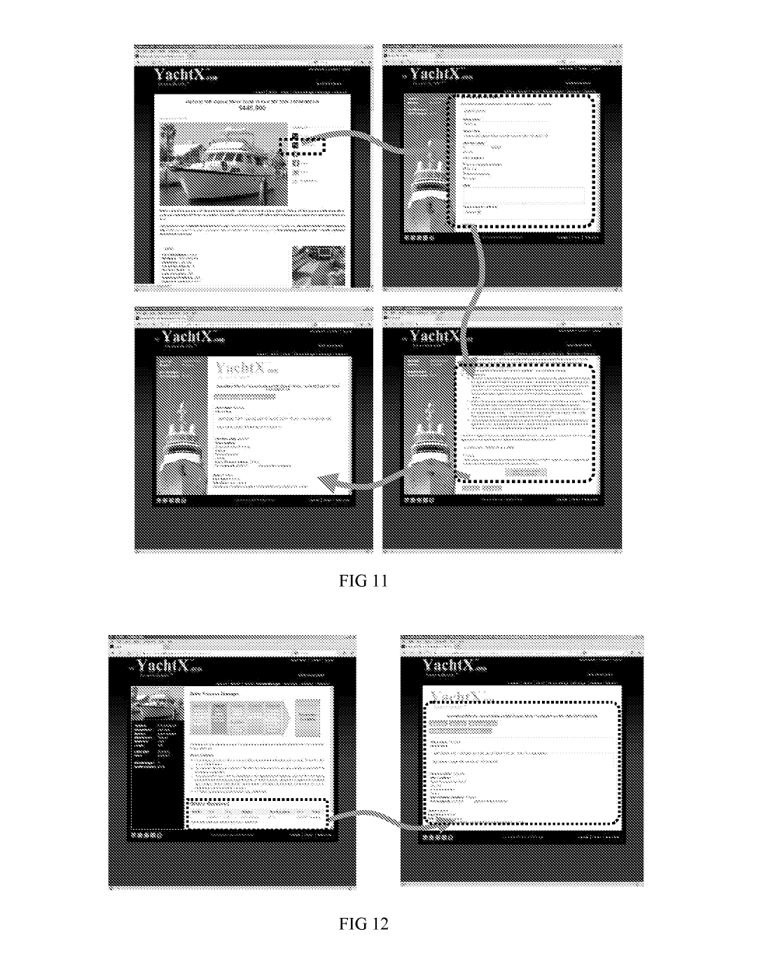

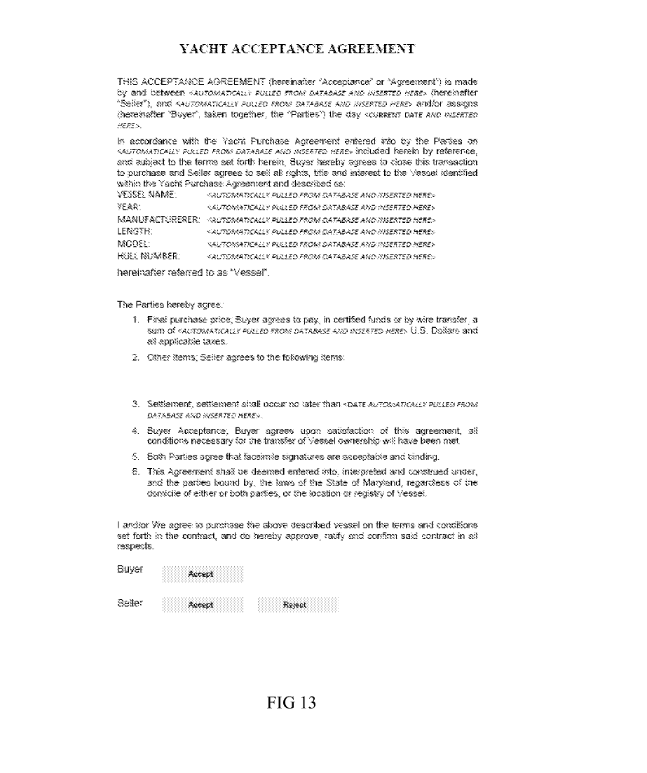

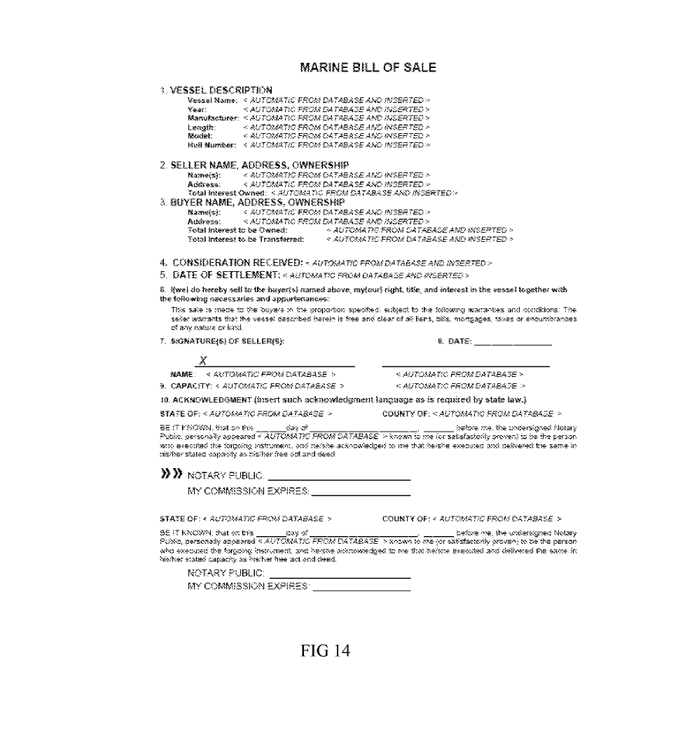

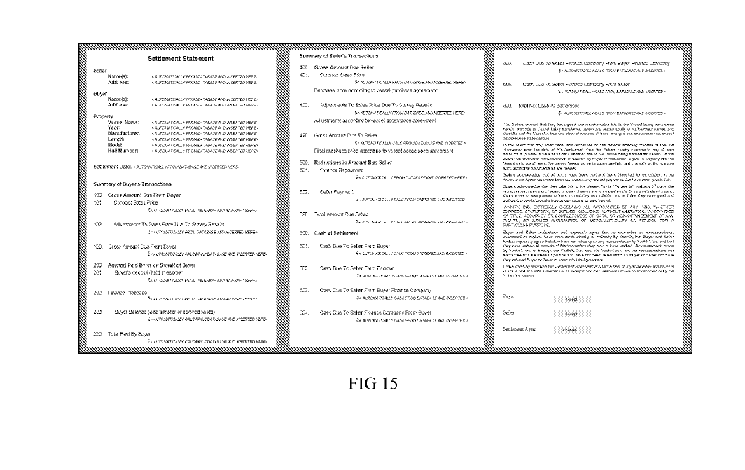

The automated HVI marketing and sales facilitation in the present disclosure provides a capability for managing the purchase and sales process (representative example FIG. 10); wherein said purchase and sales process includes capabilities for i) buyers to submit offers to purchase an HVI made for sale through the present invention (representative example FIG. 11), ii) sellers to receive notification of said offer (representative example FIG. 12), iii) the seller to respond to said offer by rejecting or by accepting said offer or by proposing a counter offer to buyer, iv) the buyer to receive notification of the seller's response, v) the buyer and seller to respond to each other's offers, reach an agreement or otherwise terminate negotiations, and archive all purchase offers and counter offers by date and party (representative example 1002) vi) a long-form purchase and sale agreement to be created populated with relevant information with agreement acceptance indicated, vii) good-faith deposit to be calculated and deposited in an escrow account, viii) responses are timed and reminders automatically sent to assist in management of negotiations in a timely manner; wherein said purchase and sales process includes capabilities for managing the fulfillment of the terms and conditions of the purchase and sales agreement as defined by the buyer and agreed by the seller and buyer, including the creation and negotiation of an acceptance agreement (representative example FIG. 13); wherein said purchase and sales process includes capabilities for the buyer to select, retain and communicate with in a secure environment one or more third-party service providers required to complete the purchase and sales transaction; wherein said purchase and sales process includes capabilities for creation on closing documents including a bill of sale (representative example FIG. 14) and a settlement statement (representative example FIG. 15) or other such closing documents; wherein said purchase and sales process includes capabilities for managing all interactions under specific time controls; wherein said purchase and sales process includes capabilities for guiding the buyer and seller through the purchase and sales processes.

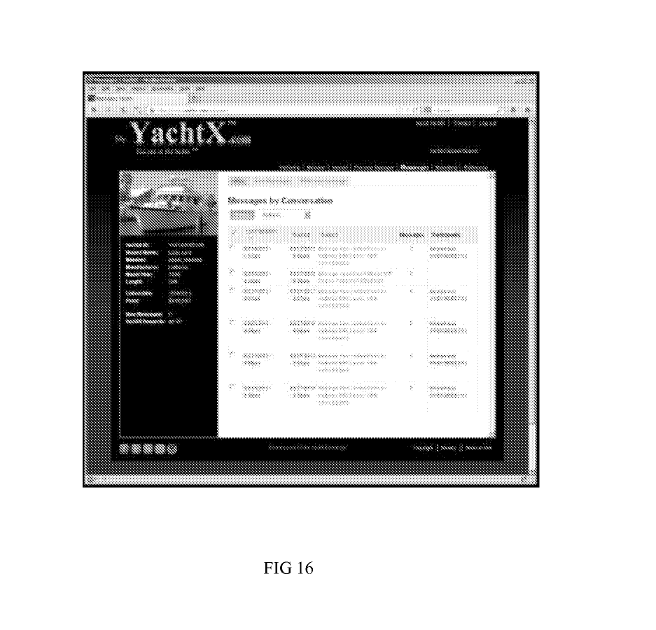

The automated HVI marketing and sales facilitation in the present disclosure provides a capability for multi-modal communications including public anonymous inquiry and response, private messaging and document passing (representative example FIG. 16), automatic generation and transmission of certain event alerts and notifications sent by an electronic method with the use of a network; said electronic method includes one or more from the list comprising email, SMS phone text messaging, mobile App or other electronic method.

The automated HVI marketing and sales facilitation in the present disclosure provides a capability for third-party provider members to i) have access to buyer member, seller member and HVI information necessary to complete their tasks, ii) securely pass documents among members involved in a given transaction, and iii) advertise their services to buyer or seller members. Third-party providers include providers of insurance, financing, title transfer, closing/settlement facilitation, inspection, brokerage or other services appropriate and beneficial to the buyer, to the seller or both buyer and seller for the marketing or purchase and sale of seller's HVI.

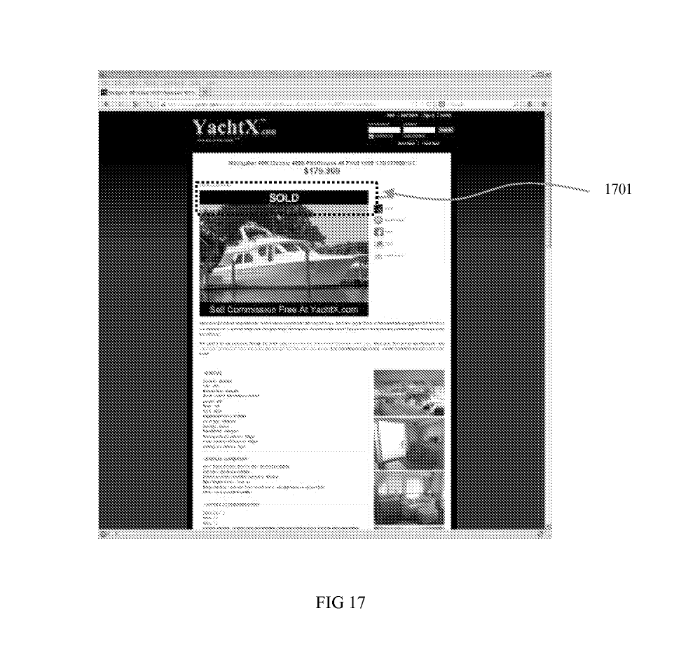

The automated HVI marketing and sales facilitation in the present disclosure provides a capability to display the sales status of an HVI (representative example FIG. 17, 1701); wherein said status is selected from a list comprising “for lease”, “for rent”, “for sale”, “sale pending”, “sale pending contingent offer” and “sold”; said sales status indication is in connection with advertising or descriptive specifications of HVIs made for sale through the Web site. Such indication is generated automatically by the system and displayed upon the Web site to reflect the then-current sales status of a given HVI.

The automated HVI marketing and sales facilitation in the present disclosure provides a capability for buyer members to i) be notified when one or more specific HVIs (sellers) change asking price, receive a purchase offer, accept a purchase offer, present an open house or other marketing event, and when each HVI meeting buyer's selection attributes becomes available for sale through the present invention, ii) submit and negotiate an offer to purchase one or more HVI made for sale through the service, iii) obtain review information of third-party providers submitted by other members, iv) access market information provided by the present invention, v) communicate privately and provide information securely with other members, vi) be guided through the sales transaction process, and vii) locate and hire third-party service providers.

The automated HVI marketing and sales facilitation in the present disclosure provides a capability for non-member users to i) search, locate and review an advertisement for an HVI, ii) to submit inquiries to the seller of an HVI, and iii) to request membership status for themselves.

In another embodiment, the automated HVI marketing and sales facilitation in the present disclosure provides a repository for sharing the quality of their experience of working with third-party service providers and other domain-relevant services, as well as a capability to provide an overall rating of the performance of said providers with other members.

In another embodiment, the automated HVI marketing and sales facilitation in the present disclosure provides aggregated data for sales pricing, asking price, time on market, month of sale, geographical location (e.g. State or Province) to seller members. In this context, the data is provided without seller members' personal information and is provided for the purpose of assisting seller members establish market valuation of their HVI or buyer members establish a valuation of an HVI for which they submit an offer to purchase.

In another embodiment, the automated HVI marketing and sales facilitation in the present disclosure provides seller members with automated transfer of selected HVI information and photographic image files to one or more third-party Web or print media advertisers.

In another embodiment, the automated HVI marketing and sales facilitation in the present disclosure provides seller members with the ability to announce to previous inquirers and buyer members who have requested to be informed when HVIs matching their search attributes i) announce an open house or other marketing events the seller member or their HVI will participate in, ii) has received a purchase offer that the seller member has not yet responded to, and iii) has conditionally accepted an offer containing a kick-out contingent condition wherein the offeror has first refusal right to remove the contingent condition if seller member receives an offer that does not contain such a contingent condition.

In another embodiment, the automated HVI marketing and sales facilitation in the present disclosure provides a private virtual environment exclusively for each HVI seller, buyer, broker or brokerage company and third-party service provider who is a registered member of the automated HVI marketing and sales facilitation services. The aforementioned private virtual environment is accessible to each member via a dashboard unique to each member's account, and provides interactive services delivered to each member over the network using the aforementioned member's computing device. Member account security is enforced by password protection access control and SSL or other encryption, the access method to the aforementioned network is not particularly limited.

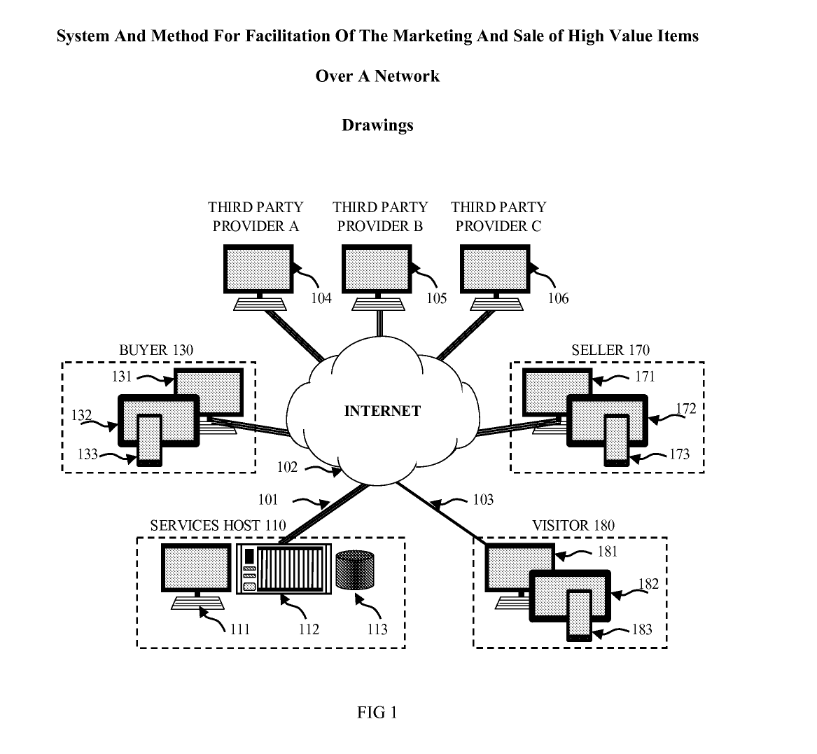

FIG. 1 depicts a constitutional drawing of a network topology reflecting a client-server architecture for the delivery of automated HVI marketing and sales facilitation services to and among members, as well as allowing non-member visitors limited access to information relating to HVIs made for sale through the Services. 101 represents encrypted secure access virtual connections between members and member services provided by the services host system 110 (server side) over the public Internet 102. 103 represents non-secured access to certain information made available to the general public relating to seller HVI or other such information. Services host system comprises at least an administrative computer console 111, at least one database 113 containing member data, and a set of server and network equipment housing machine-readable software modules providing at least a web server, email servers, electronic commerce gateway (or interface to one or more), SMS telecommunications gateway (or interface to one or more), application server, application program interface (“API”), operating system/device drivers, secure access control, secure access encryption, firewall, support for mobile applications, a host web site, a content management system, a database and database management system represented by 113. Seller 170 (client side) may access member services via a computer 171, a tablet computer 172, a smartphone 173 or other such Web-enabled device. Buyer 130 (client side) may access member services via a computer 131, a tablet computer 132, a smartphone 133 or other such Web-enabled device. Third party providers (client side) may access member services via a computer such as shown by 104, 105 and 106. The number of third-party service providers is not particularly limited. Visitors 180 (client side) may access public services via a computer 181, a tablet computer 182, a smartphone 183 or other such Web-enabled device. Client side viewing of services may be performed using a Web browser, mobile application (App) or other such Web-enabled software.

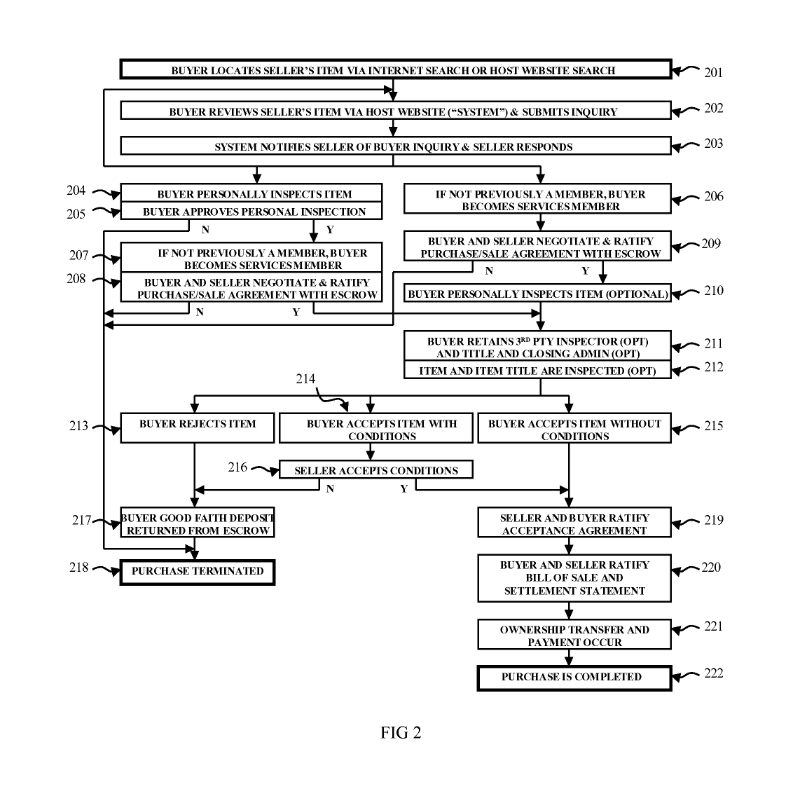

FIG. 2 depicts a flow diagram depicting a representative example of services delivered by the system and method described herein, such services delivered to and for the benefit of members; a summary of events, gating logic and operations pertaining to the consummation of a purchase and sale of a HVI between a seller member and a buyer member. A buyer first locates the advertisement specification 201 for seller's HVI on the services Web site by means of referral from another Web site (e.g. a search engine) or by performing a search upon services Web site or App. Buyer visitor may then review information pertaining to seller member's HVI which information content is provided by seller member, buyer visitor may submit one or more inquiries related to HVI to seller member 202. The services system notifies the seller member of the inquiry by electronic method. Seller member may read and respond to the inquiry by logging into seller's dashboard 203. Buyer may then arrange with the seller member for buyer or buyer's assigned representative to personally inspect seller's HVI 204 and thereby elect to proceed with the processes to purchase said HVI or not to do so 205. If buyer visitor elects not to proceed with said purchase, the purchase transaction is terminated 218. Otherwise, if the buyer is not already a buyer member, the buyer visitor becomes a buyer member 207 and enters into negotiation through the services Web site with seller member, to ratify a purchase and sale agreement with a good faith deposit submitted to an escrow account operated by the services provider or a third-party escrow agency 208. If a purchase and sales agreement is not ratified and good faith deposit is not escrowed, the purchase transaction is terminated 218. Otherwise, buyer member may then locate and retain a third-party inspector and title and closing administrator 211, and proceed with HVI and title inspections 212. As an alternative to 204, buyer visitor may become a buyer member 206 prior to personal inspection of the HVI, choosing to negotiate a purchase and sale agreement with good faith deposit 209 that includes a conditional provision for buyer member or their assigned representative to later personally inspect the HVI 210. If a purchase and sales agreement is not ratified and good faith deposit is not escrowed, the purchase transaction is terminated 218. Otherwise, buyer member may then locate and retain a third-party inspector and title and closing administrator 211, and proceed with HVI and title inspections 212. Pending the outcome of HVI and title inspections, the buyer member may reject the HVI 213, accept the HVI with new conditions 214, or accept the HVI without changes to the purchase and sale agreement 215. If 214, the seller must accept or reject the new conditions 216. If the seller rejects the new conditions, buyer's good faith deposit is returned to the buyer 217 and the purchase is terminated 218. Otherwise, the seller and buyer ratify an acceptance agreement 219, bill of sale and settlement statement with fund distribution 220, ownership transfer and payment is made 221 and purchase is complete 222.

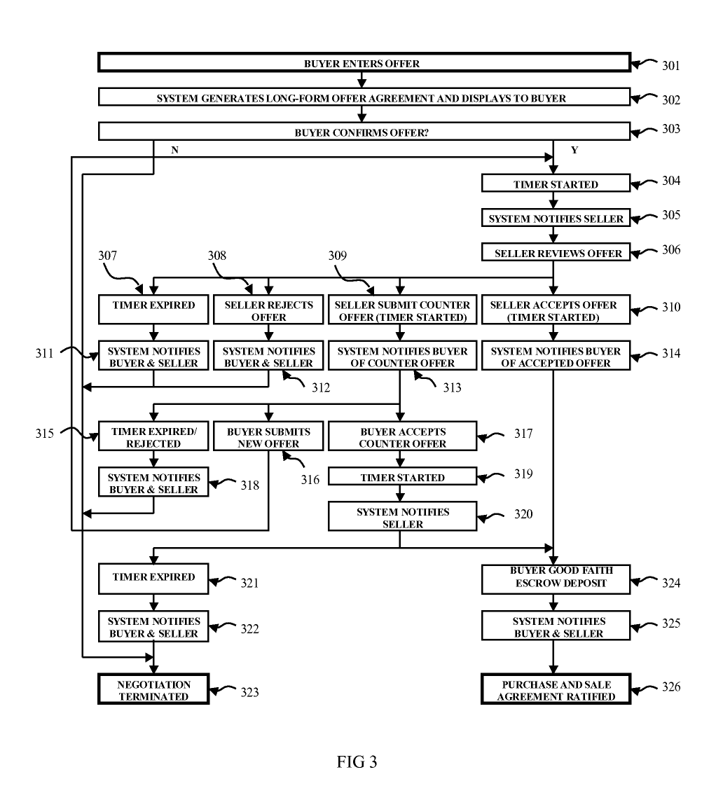

FIG. 3 depicts a flow diagram depicting a representative example of services delivered by the system and method described herein, such services delivered to and for the benefit of members; a greater degree of detail of events, gating logic and operations pertaining to the facilitation of negotiation of a price and terms of purchase and sale of a HVI between a seller member and a buyer member. The buyer member locates the HVI advertisement specification Web page and clicks the link to submit an offer for the HVI, and offeror name and HVI ID and description fields are automatically populated, the buyer enters the offer price, selects offer conditions (e.g. personal inspection, third party inspection, trial, finance and other), selects time to complete closing/settlement by drop-down box, and clicks “next” 301. Buyer member then may read, print or save the full purchase and sale agreement and agree to its terms and submit the offer 302. If buyer member does not agree to the terms and submit the offer, negotiation is terminated 323. Otherwise, a timer begins within which the seller must respond to said offer 304, the seller is notified of the offer by electronic method 305. Seller member may read and respond to the offer by logging into seller's dashboard 306. Seller member may then allow the timer to expire 307, reject the offer 308, accept the offer 310, or submit a counter-offer 309. If the seller member allows the timer to expire or rejects buyer's offer, the buyer member is notified 311 or 312 respectively and negotiation is terminated 323. If the seller member accepts the buyer member's offer 314, the buyer is notified 314 and a timer is started within which time the buyer must provide good faith deposit as calculated by the service to an escrow account of the service or a third party designated and agreed by the buyer and seller 324. If the escrow deposit timer expires 321, the buyer and seller are notified 322 and negotiation is terminated 323. Otherwise if the timer does not expire and good faith funds are deposited in escrow in a timely fashion 324, seller and buyer are notified 325 and purchase agreement is ratified 326 and the sales process proceeds. Alternatively, if the seller submits a counter offer 309, the buyer is notified 313 by electronic method. Buyer member may read and respond to the offer by logging into buyer's dashboard. Buyer member may then allow the timer to expire 315, reject the offer 315, accept the offer 317, or submit a new offer 316. If the buyer member allows the timer to expire or rejects buyer's offer, the buyer member is notified 318 and negotiation is terminated 323. If the buyer member accepts the seller member's counter offer 317, the seller is notified 320 and a timer is started within which time the buyer must provide good faith deposit as calculated by the service to an escrow account of the service or a third party designated and agreed by the buyer and seller 319. If the escrow deposit timer expires 321, the buyer and seller are notified 322 and negotiation is terminated 323. Otherwise if the timer does not expire and good faith funds are deposited in escrow in a timely fashion 324, seller and buyer are notified 325 and purchase agreement is ratified 326 and the sales process proceeds.

The computer or computers used for server or client side functionality includes at least two machine-readable media (volatile RAM and non-volatile memory) on which is stored one or more sets of software instructions embodying any one or more of the methodologies or functions described herein. The software may be transmitted or received over a network via the network interface device.

The term “machine-readable media” should be taken to include a single medium or multiple media (e.g., a centralized or distributed database, and/or associated caches and servers) that store the one or more sets of instructions. The term “machine-readable media” shall also be taken to include any medium that is capable of storing, encoding or carrying a set of instructions for execution by the machine and that cause the machine to perform any one or more of the methodologies of the present invention.

Thus, a method and system to provide facilitation of the marketing and sales processes of HVIs over a network have been described. Although specific exemplary embodiments of the invention have been described, it is understood that the present invention should not be limited to those embodiments, but various additions, changes and modifications can be made by one skilled in the art within the spirit and scope of the invention as hereinafter claimed.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Accordingly, the specification and drawings are to be regarded in an illustrative rather than a restrictive sense. Thus, the present disclosure is limited only by the claims.

What is claimed is:

1. A computer implemented method to facilitate a transaction in a network-based automated sales facility, the method including: presenting over a network and via a software application executing on a client computer:
provide a private, secure virtual environment for each registered user, using private user accounts and interactive control dashboards though which process facilitation is provided for the supported user types seller, buyer, broker and third-party service provider;
a means of automatically generating a listing for the purpose of marketing an item for sale, details about the item provided by the selling party user using the user's computing device, wherein the listing comprises i) a searchable advertisement page with a unique web address accessible by public world wide web, and ii) marketing collateral in the form of a file comprising a brochure and another file comprising a for-sale sign, the brochure and sign further comprising at least the text “For Sale”, a summary description of the aforementioned high-value item for sale, and a machine-readable code logically associated with the advertisement web address such that when the aforementioned code is read by a network-connected mobile or portable electronic computing device so equipped, the aforementioned device, though an application executing on the aforementioned device, displays the aforementioned web advertising page associated with the high-value item;
a means of storing and providing a plurality of listings to a buying party user, monitoring selection of one of the plurality of listings by the user to identify a selected listing, retrieving item details of the selected listing from a database, displaying to the user i) the details of the item associated with the selected listing, ii) a means to submit a mutually anonymous inquiry about the listing item and iii) a means to initiate the process of submitting an offer to purchase the item represented in the selected listing;
a means for submitting an offer to purchase an item associated with a listing, the offer information collected from the registered buying party user in a pre-determined format and automatically causing the generation of a full-form purchase agreement, and issuing a proactive notification to the selling party user indicating the existence of the offer and presenting the terms thereof using computer automation and over an electronic network;
a means of facilitating negotiation between the buying party and the selling party for the purpose of reaching an agreement to purchase and sell the item associated with a listing, wherein the facilitation provides timed process controls with proactive user notifications;
a means of facilitating the completion a complex sales transaction comprising multiple phases by i) presenting the buying and selling party users with work flow guidance in both static and dynamic forms, the dynamic form is automatically presented to the buying and selling party users via their respective dashboards, ii) by automatically generating populated documents and securely distributing the documents among and information participating third-party service provider users selected by the buying party, iii) by proactively providing automated proactive notifications to the users, and iv) by enforcing timed process controls.

2. The method of claim 1 wherein:
the software application executing on the user's computing device accessing the network-based automated sales facility is a web browser or a mobile App; and
the media for distributing proactive notifications to users are at least one selected from a list comprising email, SMS text messaging, instant messaging and mobile App messaging.

3. The method of claim 1 which includes presenting the buying party user with third-party providers of financing, insurance, inspection, title inspection, closing management, legal advice, delivery or relocation services in connection with the purchase transaction associated with a listing; presenting the buying party user with a list of such third-party providers, a means to communicate a request for engagement to a selected third-party service provider, and automatically distributing relevant information with engaged providers within the secure computing virtual environment.

4. A computer-readable storage medium persistently storing a program to facilitate a transaction in a network-based automated sales facility, wherein the program, when executed, instructs a computer processor to perform the following operations: the method including: presenting over a network and via a software application executing on a client computer:
provide a private, secure virtual environment for each registered user, using private user accounts and interactive control dashboards though which process facilitation is provided for the supported user types seller, buyer, broker and third-party service provider;
a means of automatically generating a listing for the purpose of marketing an item for sale, details about the item provided by the selling party user using the user's computing device, wherein the listing comprises i) a searchable advertisement page with a unique web address accessible by public world wide web, and ii) marketing collateral in the form of a file comprising a brochure and another file comprising a for-sale sign, the brochure and sign further comprising at least the text “For Sale”, a summary description of the aforementioned high-value item for sale, and a machine-readable code logically associated with the advertisement web address such that when the aforementioned code is read by a network-connected mobile or portable electronic computing device so equipped, the aforementioned device, though an application executing on the aforementioned device, displays the aforementioned web advertising page associated with the high-value item;
a means of storing and providing a plurality of listings to a buying party user, monitoring selection of one of the plurality of listings by the user to identify a selected listing, retrieving item details of the selected listing from a database, displaying to the user i) the details of the item associated with the selected listing, ii) a means to submit a mutually anonymous inquiry about the listing item and iii) a means to initiate the process of submitting an offer to purchase the item represented in the selected listing;
a means for submitting an offer to purchase an item associated with a listing, the offer information collected from the registered buying party user in a pre-determined format and automatically causing the generation of a full-form purchase agreement, and issuing a proactive notification to the selling party user indicating the existence of the offer and presenting the terms thereof using computer automation and over an electronic network;
a means of facilitating negotiation between the buying party and the selling party for the purpose of reaching an agreement to purchase and sell the item associated with a listing, wherein the facilitation provides timed process controls with proactive user notifications;
a means of facilitating the completion a complex sales transaction comprising multiple phases by i) presenting the buying and selling party users with work flow guidance in both static and dynamic forms, the dynamic form is automatically presented to the buying and selling party users via their respective dashboards, ii) by automatically generating populated documents and securely distributing the documents among and information participating third-party service provider users selected by the buying party, iii) by proactively providing automated proactive notifications to the users, and iv) by enforcing timed process controls.

5. The computer-readable storage medium of claim 4 wherein:
the software application executing on the user's computing device accessing the network-based automated sales facility is a web browser or a mobile App; and
the media for distributing proactive notifications to users are at least one selected from a list comprising email, SMS text messaging, instant messaging and mobile App messaging.

6. The computer-readable storage medium of claim 4 which includes presenting the buying party user with third-party providers of financing, insurance, inspection, title inspection, closing management, legal advice, delivery or relocation services in connection with the purchase transaction associated with a listing; presenting the buying party user with a list of such third-party providers, a means to communicate a request for engagement to a selected third-party service provider, and automatically distributing relevant information with engaged providers within the secure computing virtual environment.

7. A system comprising one or more computers and one or more storage devices storing instructions that are operable, when executed by the one or more computers, to cause the one or more computers to perform operations to facilitate a transaction in a network-based automated sales facility, the method including: presenting over a network and via a software application executing on a client computer:
provide a private, secure virtual environment for each registered user, using private user accounts and interactive control dashboards though which process facilitation is provided for the supported user types seller, buyer, broker and third-party service provider;
a means of automatically generating a listing for the purpose of marketing an item for sale, details about the item provided by the selling party user using the user's computing device, wherein the listing comprises i) a searchable advertisement page with a unique web address accessible by public world wide web, and ii) marketing collateral in the form of a file comprising a brochure and another file comprising a for-sale sign, the brochure and sign further comprising at least the text “For Sale”, a summary description of the aforementioned high-value item for sale, and a machine-readable code logically associated with the advertisement web address such that when the aforementioned code is read by a network-connected mobile or portable electronic computing device so equipped, the aforementioned device, though an application executing on the aforementioned device, displays the aforementioned web advertising page associated with the high-value item;
a means of storing and providing a plurality of listings to a buying party user, monitoring selection of one of the plurality of listings by the user to identify a selected listing, retrieving item details of the selected listing from a database, displaying to the user i) the details of the item associated with the selected listing, ii) a means to submit a mutually anonymous inquiry about the listing item and iii) a means to initiate the process of submitting an offer to purchase the item represented in the selected listing;
a means for submitting an offer to purchase an item associated with a listing, the offer information collected from the registered buying party user in a pre-determined format and automatically causing the generation of a full-form purchase agreement, and issuing a proactive notification to the selling party user indicating the existence of the offer and presenting the terms thereof using computer automation and over an electronic network;
a means of facilitating negotiation between the buying party and the selling party for the purpose of reaching an agreement to purchase and sell the item associated with a listing, wherein the facilitation provides timed process controls with proactive user notifications;
a means of facilitating the completion a complex sales transaction comprising multiple phases by i) presenting the buying and selling party users with work flow guidance in both static and dynamic forms, the dynamic form is automatically presented to the buying and selling party users via their respective dashboards, ii) by automatically generating populated documents and securely distributing the documents among and information participating third-party service provider users selected by the buying party, iii) by proactively providing automated proactive notifications to the users, and iv) by enforcing timed process controls.

8. The system of claim 7 wherein:
the software application executing on the user's computing device accessing the network-based automated sales facility is a web browser or a mobile App; and
the media for distributing proactive notifications to users are at least one selected from a list comprising email, SMS text messaging, instant messaging and mobile App messaging.

9. The system of claim 7 which includes presenting the buying party user with third-party providers of financing, insurance, inspection, title inspection, closing management, legal advice, delivery or relocation services in connection with the purchase transaction associated with a listing; presenting the buying party user with a list of such third-party providers, a means to communicate a request for engagement to a selected third-party service provider, and automatically distributing relevant information with engaged providers within the secure computing virtual environment.
